(19) United States
(12) Patent Application Publication
(10) Pub. No.: US 2009/0130577 A1
(43) Pub. Date: May 21, 2009

(54) RECORDING MEDIUM FOR ELECTROPHOTOGRAPHIC APPLICATIONS

(75) Inventors: Hae-ree JOO, Anyang-si (KR); Jae-hwan Kim, Seoul (KR); Kil Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/244,043

(22) Filed: Oct. 2, 2008

(30) Foreign Application Priority Data
Nov. 16, 2007 (KR) 2007-117441

(51) Int. Cl. G03G 5/153; G03G 15/00

(52) U.S. Cl. 430/96; 430/56

(57) ABSTRACT

A recording medium for electrophotographic applications includes a base layer and an outermost coating layer containing a porous adsorptive material. According to the present general inventive concept, since a porous adsorptive material is contained in an outermost coating layer of the recording medium, volatile hazardous material generated from toner during a printing operation can be directly adsorbed on the recording medium to efficiently decrease or remove an occurrence of volatile hazardous material, so that a separate filter or apparatus to remove the volatile hazardous material is not needed and thus economical effects can be obtained.

### CROSS-REFERENCE TO RELATED APPLICATIONS

This application claims priority under 35 U.S.C. §119(a) from Korean Patent Application No. 10-2007-0117441, filed on Nov. 16, 2007, in the Korean Intellectual Property Office, the disclosure of which is incorporated herein in its entirety by reference.

### BACKGROUND OF THE INVENTION

1. Field of the Invention

The present general inventive concept relates to a recording medium, and more particularly, to a recording medium for electrophotographic applications, the recording medium including an outermost coating layer that contains a porous adsorptive material.

2. Description of the Related Art

Due to a rapid spread of computer technologies, computer printing applications have considerably increased in recent years. In this regard, dot impact printers, laser printers, thermal printers, and inkjet printers are frequently used. Generally, laser printers employing an electrophotographic process are mostly used by consumers because of advantages such as rapid printing speed, high resolution printing, etc.

In an electrophotographic process used in copiers or printers, an image is formed in 5 operations. In the first operation, a photoconductor drum or belt is charged to a uniform potential in a dark place. In the second operation, an electrostatic latent image is formed by scanning a laser beam on the photoconductor drum or belt. In the third operation, the electrostatic latent image is developed into a toner image by exposing the electrostatic latent image to a charged toner such that the charged toner is attached on the electrostatic latent image by an electrostatic force. In the fourth operation, the toner image is transferred on a recording medium while the recording medium passes between the photoconductor drum or belt and a corona roller. At this time, the toner image can be transferred on the recoding medium by an electrostatic force only when the recording medium has a predetermined conductivity. In the fifth operation, the toner image is transferred on the recording medium, and is performed by hot fusing, i.e., by applying heat and pressure to the printing medium using a roller.

FIG. 3 illustrates an operation of fusing a toner image on a recording medium through hot fusing. As illustrated in FIG. 3, a toner image 31 transferred on a recording medium 30 is fused on the recording medium while passing through a pair of fusing rollers 32.

However, conventional printers employing such fusing rollers may generate materials hazardous to the environment during the printing operation performed under high temperature and pressure conditions have been reported.

Thus, as environmental regulations are become stricter, environmental-friendly products to address this problem should be developed.

### SUMMARY OF THE INVENTION

The present general inventive concept relates to a recording medium having an outermost coating layer containing a porous adsorptive material to adsorb volatile hazardous material generated from toner during a printing operation.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a recording medium for electrophotographic applications, the recording medium including a base layer, and an outermost coating layer containing a porous adsorptive material.

When the recording medium further includes a toner receptor layer formed on one surface of the base layer or toner receptor layers respectively formed on both surfaces of the base layer, the outermost coating layer may be the toner receptor layer.

When the recording medium includes the base layer, a toner receptor layer formed on one surface of the base layer or toner receptor layers respectively formed on both surfaces of the base layer, and an uppermost surface layer formed on the toner receptor layer, the outermost coating layer may be the uppermost surface layer.

The porous adsorptive material may be at least one selected from the group consisting of silica, active carbon, bentonite, montmorillonite, illite and elvan.

The porous adsorptive material may have an amount of 0.1 part by weight to 15 parts by weight based on 100 parts by weight of a filler.

The base layer may be one selected from the group consisting of synthetic paper, wood free paper, art paper, coated paper, mixed paper, baryta paper, impregnated paper, paper board, cellulose fiber paper, transparent or semi-transparent plastic film, and a foamed sheet, and a laminated structure of two or more of the above materials.

The base layer may have a thickness of 25 μm to 260 μm.

The outermost coating layer may further contain a filler and a binder.

The filler may be an inorganic filler selected from the group consisting of kaolin clay, silica, calcium carbonate, talc, aluminum hydroxide, satin white, titanium dioxide, calcined clay, zinc oxide and barium sulfate, or an organic filler selected from the group consisting of styrene-based resin, acryl-based resin, polyvinyl chloride and polycarbonate.

The binder may contain at least one component selected from the group consisting of polyvinyl alcohol, polyvinylpyrrolidone, methyl cellulose, hydroxypropylmethyl cellulose, gelatin, polyethyleneoxide, acryl-based polymer, polyester, polyurethane, epoxy resin, latex, and quaternary ammonium copolymer.

The toner receptor layer may further contain an additive.

The toner receptor layer may have a thickness of 1 μm to 20 μm.

The uppermost surface layer may have a thickness of 5 μm to 15 μm.

The foregoing and/or other aspects and utilities of the general inventive concept may also be achieved by providing a recording medium usable with an electrophotographic system, the recording medium including a base layer having two surfaces, and a toner receptor layer having a porous adsorptive material disposed on one or more of the two surfaces of the base layer.

The toner receptor layer may be disposed on the two surfaces of the base layer.

### BRIEF DESCRIPTION OF THE DRAWINGS

The above and other aspects and utilities of the present general inventive concept will become more apparent by describing in detail exemplary embodiments thereof with reference to the attached drawings in which:

FIG. 1 is a sectional view illustrating a recording medium for electrophotographic applications, according to an embodiment of the present general inventive concept;

FIG. 2 is a sectional view illustrating a recording medium for electrophotographic applications, according to another embodiment of the present general inventive concept; and

FIG. 3 illustrates an operation of fusing a toner on a recording medium for electrophotographic applications, according to an embodiment of the present invention.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

The present general inventive concept relates to a recording medium for electrophotographic applications, the recording medium having an outermost coating layer containing a porous adsorptive material.

Printer toner is generally formed of an organic material. In a fusing operation, the organic material is fused on a recording medium passing through a fuser unit via high temperature heat and pressure. During the fusing operation, volatile organic compounds, which may cause environmental contamination and are harmful to users, may be generated.

An embodiment of the present general inventive concept includes a recording medium for electrophotographic applications, on which a toner is directly transferred and fused, has an outermost coating layer containing a porous adsorptive material to directly adsorb hazardous material generated during the fusing operation. Thus, environmental contamination or health hazards can be prevented.

The recording medium includes a base layer and one or more coating layers on the base layer.

For example, the recording medium according to the present embodiment may include a base layer and a toner receptor layer formed on one surface of the base layer or toner receptor layers respectively formed on both surfaces of the base layer, or the recording medium may include a base layer and a toner receptor layer formed on one surface of the base layer or toner receptor layers respectively formed on both surfaces of the base layer, and an uppermost surface layer formed on the toner receptor layer.

In the former case, the toner receptor layer is the outermost coating layer of the recording medium, and in the latter case, the uppermost surface layer is the outermost coating layer of the recording medium.

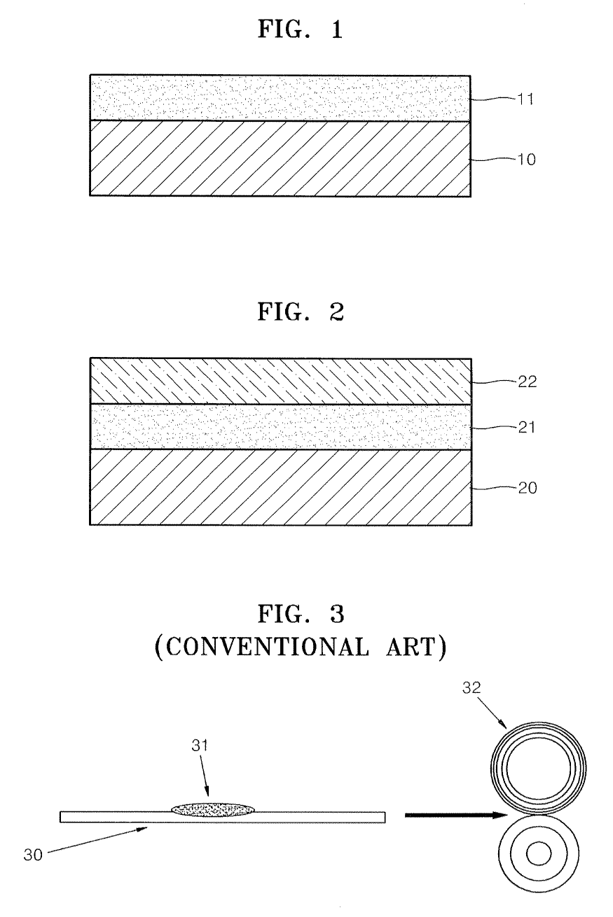

FIG. 1 is a sectional view illustrating a recording medium for electrophotographic applications according to the present embodiment. Referring to FIG. 1, the recording medium includes a base layer 10 and a toner receptor layer 11 formed on the base layer 10.

The base layer 10 may be a conventional layer used for recording media, and is not limited to any particular type. Thus, the base layer 10 can be properly selected from various types of conventional base layers according to smoothness, brightness, anti-static electricity, fusibility, and other characteristic requirements. Specific examples of the base layer 10 include paper supports, such as synthetic paper (e.g., polyolefin- or polystyrene-based synthetic paper), wood free paper, art paper, coated paper, mixed paper made from synthetic resin pulp, for example, polyolefin or the like, and natural pulp, baryta paper, synthetic resin- or emulsion-impregnated paper, synthetic rubber latex-impregnated paper, paper board, and cellulose fiber paper. Other specific examples of the base layer 10 include plastic film supports, such as polyolefin, polyvinyl chloride, polyethylene terephthalate, polystyrene, poly methacrylate and polycarbonate, etc. In addition, a white opaque film made by adding a filler to any of these synthetic resins, or a foamed sheet can be used for the base layer 10. The supports can be used alone or in combinations of two or more, for example, a laminate of cellulose fiber paper and synthetic paper, or a laminate of cellulose fiber paper and plastic film.

A base layer with a high level of smoothness may be used. For example, a base layer having a surface roughness (or smoothness) of 210 seconds or more as measured by the Bekk method (KSM7028) can be used. A base layer having a surface roughness (or smoothness) of 250 seconds or more can also be used. If the smoothness is less than 210 seconds, printing quality may be degraded in an image forming operation. A thickness of the base layer 10 may be set properly according to applications of the recording medium, such as, in a range of 25 μm to 260 μm, including a range of 75 μm to 220 μm. If the base layer 10 has insufficient adhesive force with respect to a toner receptor layer (to be described below), a surface of the base layer may be subjected to a primer treatment or a corona discharge treatment.

The toner receptor layer 11 can include well known components used in conventional recording media, such as a filler and a binder. The filler may be an inorganic filler or an organic filler.

The inorganic filler has a mean volume diameter of 2.5 μm or less, such as, a mean volume diameter in the range of 0.1 μm to 2.0 μm. Examples of the inorganic filler include kaolin clay, silica, calcium carbonate, talc, aluminum hydroxide, satin white, titanium dioxide, calcined clay, zinc oxide, barium sulfate and the like. Examples of the organic filler include: styrene-based resin, such as polystyrene, poly methylstyrene or the like; acryl-based resin, such as poly methacrylate methyl, poly acrylonitrile or the like; polyvinyl chloride and polycarbonate. The aforementioned fillers can be used in combination of two or more in a mixing ratio.

The binder includes at least one selected from the group consisting of polyvinyl alcohol, polyvinylpyrrolidone, methyl cellulose, hydroxypropylmethyl cellulose, gelatin, polyethyleneoxide, acryl-based polymer, polyester, polyurethane, epoxy resin, latex, and quaternary ammonium copolymer.

For example, latex, such as styrene-butadiene latex, styrene-butadiene-acrylonitrile latex, or acryl-based latex or the like can be used.

An amount of the binder is 5 parts by weight to 900 parts by weight, such as 5 parts by weigh to 600 parts by weight based on 100 parts by weight of filler contained in a toner receptor layer. If the amount of the binder is less than 5 parts by weight, an adhesive force to the base layer 10 is weakened, and if the amount of the binder exceeds 900 parts by weight, most of the filler is buried in the binder, and thus the filler does not perform an inherent function thereof.

In order to improve stability of a printed image or the toner receptor layer and processing characteristics of a recording medium, physical properties of the toner receptor layer 11 according to the present general inventive concept can be improved by further using various additives. Examples of these additives include antistatic agent, cross linking agent, dye, light diffusing agent, pH regulating agent, antioxidant, antifoaming agent, defoamer, leveling agent, lubricant, anti-curling agent, surface regulating agent, thickening agent, antidegradation agent, ozone antidegradation agent, and antiseptic.

Particularly, since in electrophotographic printing, a toner is charged and the charged toner is fused on printing paper, electrical conductivity of printing paper has a great influence on forming a precise image. Since the electrical conductivity of printing paper can be expressed as the sheet resistance of a coated layer of the printing paper, in the present specification, the terms sheet resistance and electrical conductivity are used exchangeably. Thus, when selecting a component of toner or the base layer 10, a polymer with an electrical conductivity may be used, or an additive, for example, an antistatic agent and the like, may be added so as to substantially increase the electrical conductivity thereof. Examples of the antistatic agents, which are conductive additives, include inorganic salts, such as sodium chloride and calcium chloride, polyvalent alcohols, such as glycerin, propyleneglycol, ethyleneglycol, polyethyleneglycol, trimethyleneglycol, sorbitol, and quaternary ammonium salt. Since these conductive additives provide adequate electrical conductivity, they can prevent paper charging and eliminate a problem in continuous feeding of papers due to the occurrence of static electricity. Accordingly, these conductive additives are generally referred to as antistatic agents rather than conductivity-providing agents.

Regardless of using a conductive polymer or adding an antistatic additive to toner or the base layer 10, a sheet resistance of the toner receptor layer 11 may be kept at 10⁹ Ω to 10¹⁴ Ω (measured at a temperature of 20° C. and a relative humidity of 20%) in order to fuse the toner and prevent the toner from scattering. In conventional recording media, the sheet resistance is adjusted using an antistatic agent, for example, inorganic salts such as sodium chloride and calcium chloride, or quaternary ammonium salt. However, when using the respective components, controlling the sheet resistance within a predetermined range when the temperature and humidity vary is difficult. For example, at high temperature of 32° C. and high humidity of 90% RH, the sheet resistance is lowered, which causes paper transfer failure.

A total amount of an additive contained in the toner receptor layer 11 can be adjusted to 0.1 part by weight to 15 parts by weight, such as 0.1 part by weight to 10 parts by weight, based on 100 parts by weight of a filler contained in the toner receptor layer 11. If an amount of the additive is less than 0.1 part by weight, an effect of the additive is minute, and if the amount of the additive exceeds 15 parts by weight, the smoothness and coating layer strength are lowered, which may not be suitable.

The toner receptor layer 11 has a thickness of approximately 1 μm to 20 μm, such as, 5 μm to 10 μm. If the thickness of the toner receptor layer 11 is less than 1 μm, the toner receptor layer does not perform an inherent function thereof, and if the thickness of the toner receptor layer 11 exceeds 20 μm, material costs are increased and drying after coating is difficult.

The recording medium according to the present general inventive concept may further include an uppermost surface layer formed on the toner receptor layer 11. In this case, the uppermost surface layer becomes the outermost coating layer.

FIG. 2 illustrates a recording medium for electrophotographic applications according to another embodiment of the present general inventive concept. Referring to FIG. 2, a recording medium includes a base layer 20, a toner receptor layer 21 formed on the base layer 20, and an uppermost surface layer 22 formed on the toner receptor layer 21.

The uppermost surface layer 22 provides a glossy effect. The glossy effect of the uppermost surface layer 22 may be increased by adjusting an amount of a filler in the uppermost surface layer 22 to be smaller than the amount of a filler in the toner receptor layer 21 or by increasing the amount of an organic filler in the uppermost surface layer 22. The uppermost surface layer 22 may be formed of a resin layer, most of which is a binder.

Like the toner receptor layer 21, the uppermost surface layer 22 contains a filler and a binder.

As aforementioned, the filler contained in the uppermost surface layer 22 may be an inorganic filler or an organic filler.

The inorganic filler has a mean volume diameter of 2.5 μm or less, such as, a mean volume diameter in a range of 0.1 μm to 2.0 μm. Examples of the inorganic filler include kaolin clay, silica, calcium carbonate, talc, aluminum hydroxide, satin white, titanium dioxide, calcined clay, zinc oxide, barium sulfate and the like. Examples of the organic filler include: styrene-based resin, such as polystyrene, poly methylstyrene or the like; acryl-based resin, such as poly methacrylate methyl, poly acrylonitrile or the like; vinyl chloride and polycarbonate. The aforementioned fillers can be used in combination of two or more in a mixing ratio.

As aforementioned, the binder includes at least one selected from the group consisting of polyvinyl alcohol, polyvinylpyrrolidone, methyl cellulose, hydroxypropylmethyl cellulose, gelatin, polyethyleneoxide, acryl-based polymer, polyester, polyurethane, epoxy resin, latex, and quaternary ammonium copolymer.

For example, latex, such as styrene-butadiene latex, styrene-butadiene-acrylonitrile latex, acryl-based latex or the like can be used.

The amount of the binder contained in the uppermost surface layer 22 is 5 parts by weight to 900 parts by weight, such as 5 parts by weigh to 600 parts by weight based on 100 parts by weight of the filler contained in the uppermost surface layer 22. If the amount of the binder is less than 5 parts by weight, the gloss is decreased and there is no anticipated effect of absorbing ultraviolet rays. If the amount of the binder exceeds 900 parts by weight, the viscosity of a coating solution is increased, which may not be suitable.

Like the toner receptor layer 21, in order to improve stability of a printed image or the uppermost surface layer 22 and processing characteristics of the recording medium, the physical properties of the uppermost surface layer 22 according to the present embodiment can be improved by further using various additives. Examples of the respective additives include antistatic agent, cross linking agent, pigment, light diffusing agent, pH regulating agent, antioxidant, defoamer, leveling agent, lubricant, anti-curling agent, surface regulating agent, thickening agent, antidegradation agent, ozone antidegradation agent, and antiseptic.

A total amount of the additives included in the uppermost surface layer 22 may be in the range of 0.1 to 15 parts by weight, such as in the range of 0.1 to 10 parts by weight based on 100 parts by weight of the filler included in the uppermost surface layer 22. When the total amount of the additives is less than 0.1 parts by weight, an effect of addition of the additives is insignificant. When the total amount of the additives is greater than 15 parts by weight, the smoothness, transparency and strength of the uppermost surface layer are reduced.

The uppermost surface layer 22 has a thickness of approximately 5 μm to 15 μm, such as, 5 μm to 10 μm. If the thickness of the uppermost surface layer 22 is less than 5 μm, the uppermost surface layer 22 may not perform an inherent function thereof, and if the thickness of the toner receptor layer exceeds 15 μm, material costs are increased.

Examples of the porous adsorptive material contained in the uppermost surface layer 22 include minerals such as zeolite, silica, active carbon, bentonite, montmorillonite, illite and elvan. Among the above minerals, since zeolite can selectively adsorb a material according to the molecular size thereof, zeolite can effectively adsorb hazardous materials generated during a printing operation. Also, zeolite is a colorless or semitransparent white material, and thus zeolite can be used for the recording medium.

Zeolite is a representative industrial mineral used in the industry due to unique and various mineral characteristics of zeolite, and is a type of alkali or alkali-earth metal aluminum silicate hydrate. Zeolite is widely used for detergents and catalysts due to a variety thereof, uniform processing characteristic, and superior effects.

For example, since zeolite has a unique pore structure in which surface pores having a size of 2 to 10 Å are interconnected, zeolite commonly refers to a mineral group including natural and synthetic minerals having various physical and chemical characteristics useful in industrial applications.

Zeolite is classified into natural zeolites and synthetic zeolites. There are several tens to several hundred commonly known varieties of zeolites. The respective zeolites have different crystal structures, different chemical compositions, and different physical chemical characteristics, but also include large voids in crystal structures thereof through which various cations and molecules of corresponding sizes can enter and exit according to surrounding conditions.

Natural zeolites have a crystal structure of tektosilicates in which all oxygen atoms of (Si, Al)O₄ tetrahedra (that is one of the base units of silicate mineral in crystal structures) are shared with another tetrahedral and connected three-dimensionally. While quartz and feldspar minerals having the same crystal structure have a very compact structure, zeolite has a loose lattice structure (specific gravity: 2.0 to 2.3) to such a degree that large voids having a size of 2.3 Å to 7.5 Å are formed in the crystal structure. The size of a structural pore of zeolite is determined by a shape of oxygen atom rings and the number of intervening oxygen atoms that 4 to 12 oxygen atoms bonded to Si or Al form in an entrance of the structural pore. The framework composition, i.e., (Si₁₋ₓAlₓ)O₄ varys depending on a type of zeolite, and the shapes and sizes of pores also vary accordingly. In terms of the chemical composition, natural zeolite is a hydrous aluminosilicate mineral containing a small amount of cations of Na, K, Ca, Mg, Sr or Ba.

Herein, examples of the natural zeolite include clinoptilolite, mordenite, heulandite, phillipsite, chabazite, ferrierite, erionite, mesolite, natrolite, analcime, stellerite, harmotome(wellsite)1, and harmotome(wellsite)2. Particularly, among the above materials, clinoptilolite and mordenite are easily produced and have work characteristics suitable for general use.

The zeolite used in the present embodiment has a size of a few nanometers or a size smaller than that of a filler used in a toner receptor layer to improve adsorption efficiency.

An amount of the porous adsorptive material is 0.1 parts by weight to 15 parts by weight, including 0.1 parts by weight to 10 parts by weight, based on 100 parts by weight of a filler.

If the amount of the porous adsorptive material is less than 0.1 parts by weight, obtaining the effect of the present embodiment is difficult, and if the amount of the porous adsorptive material exceeds 15 parts by weight, the smoothness, transparency and strength of the uppermost surface layer are reduced, which may be not suitable.

The toner receptor layer and the uppermost surface layer of the recording medium according to the present embodiment are formed by coating and drying compositions to form the toner receptor layer and the uppermost surface layer on the base layer.

The compositions to form the toner receptor layer and the uppermost surface layer contain a solvent in addition to the solid component.

While the solvent is not limited to any particular type, water is mainly used in consideration of environmental problems and workability.

In addition to water, the solvent is selected from the group consisting of ketones, glycol ethers, alcoholic solvents, methyl cellosolve, ethyl cellosolve, dimethyl formamide and dimethyl sulfoxide. Specifically, ketones include acetone and methyl ethyl ketone, the glycol ethers include diethylene glycol and diethylene glycol mono butyl ether, and the alcoholic solvents include methanol, ethanol, butanol and isopropanol.

An amount of the solvent can be adjusted, for example, such that an amount of the solid component of compositions for the toner receptor layer and the uppermost surface layer is 5 wt % to 60 wt %. If the amount of the solid component is insufficient, drying a coated layer is difficult. Conversely, if the amount of the solid component is excessive, viscosity of a coated layer increases, so that defects, such as cracks, may be generated, i.e., surface property of the coated layer may deteriorate.

The recording medium for electrophotographic applications according to the present embodiment is formed by sequentially coating and drying the composition to form the toner receptor layer and the composition to form the uppermost surface layer on one surface or both surfaces of the base layer to form the toner receptor layer and the uppermost surface layer.

The drying can be performed, for example, in a temperature range of 50° C. to 130° C. In the drying, when a cross linking agent is contained in the coated layer, a thermal cross linking reaction is generated due to the cross linking agent. Accordingly, if the drying temperature is less than 50° C., cross linking reactivity is lowered, and if the drying temperature exceeds 130° C., yellowing may occur, which may be not suitable.

In order to improve the smoothness and gloss of the toner receptor layer after coating and drying of the toner receptor layer, a calender, such as a machine calender, a TG calender, a soft calender, and a super calender may be used on-machine (i.e., a coating method may be performed at a drying part of a paper machine in paper manufacturing) or off-machine (i.e., a method of coating paper made with a paper machine using a separate coater may be performed).

Examples according to various embodiments of the present general inventive concept will now be described. The embodiments are, however, provided for exemplary purposes and should not be construed to limit scope of the present general inventive concept.

### EXAMPLE 1

A composition to form a toner receptor layer having the following composition was prepared.

[Composition for the formation of toner receptor layer]

Calcium carbonate (product from OMAYA Co., Ltd., Hydrocarb 60 ME): 100 parts by weight

Polyvinyl alcohol (product from KURARAY Co., Ltd., PVA 105): 1.25 parts by weight

Acrylic latex (product from Hansol Chemical Co., Ltd., SAV 4720): 7.5 parts by weight

Zeolite (Zeolite, BIOCHEMIKA Co., Ltd.): 3.75 parts by weight

Sodium chloride (product from Junsei Co., Ltd.): 3.75 parts by weight

Polyethylene glycol (product from Junsei Co., Ltd.): 6.25 parts by weight

Water: 500 parts by weight

The composition to form a toner receptor layer obtained as above and a composition to form a uppermost surface layer were coated on a base paper with a basis weight of 115 g/m² using a bar coater, were dried at a temperature of 110° C. for 3 minutes to make a recording medium for electrophotographic applications, the recording medium having a toner receptor layer with a width of 15 μm.

### EXAMPLE 2

A composition to form a toner receptor layer having the following composition was prepared.

[Composition for the formation of toner receptor layer]

Calcium carbonate (product from OMAYA Co., Ltd., Hydrocarb 60 ME): 100 parts by weight

Polyvinyl alcohol (product from KURARAY Co., Ltd., PVA 105): 1.25 parts by weight

Acrylic latex (product from Hansol Chemical Co., Ltd., SAV 4720): 7.5 parts by weight

Zeolite (Zeolite, BIOCHEMIKA Co., Ltd.): 10 parts by weight

Sodium chloride (product from Junsei Co., Ltd.): 3.75 parts by weight

Polyethylene glycol (product from Junsei Co., Ltd.): 6.25 parts by weight

Water: 500 parts by weight

The composition to form a toner receptor layer obtained as above and a composition to form an uppermost surface layer were coated on a base paper with a basis weight of 115 g/m² using a bar coater, were dried at a temperature of 110° C. for 3 minutes to make a recording medium for electrophotographic applications, the recording medium having a toner receptor layer with a width of 15 μm.

### EXAMPLE 3

A composition to form a toner receptor layer and a composition to form an uppermost surface layer having the following compositions were prepared.

[Composition to form a toner receptor layer]

Calcium carbonate (product from OMAYA Co., Ltd., Hydrocarb 60 ME): 100 parts by weight

Polyvinyl alcohol (product from KURARAY Co., Ltd., PVA 105): 1.14 parts by weight

Acrylic latex (product from Hansol Chemical Co., Ltd., SAV 4720): 6.82 parts by weight

Sodium chloride (product from Junsei Co., Ltd.): 2.27 parts by weight

Polyethylene glycol (product from Junsei Co., Ltd.): 4.54 parts by weight

Water: 454.5 parts by weight

[Composition to form an uppermost surface layer]

Calcium carbonate (product from SMI Co., Ltd., Pracarb A40): 100 parts by weight

Organic filler (product from Dow Co., Ltd., DPP 3720): 1.25 parts by weight

Zeolite (Zeolite, BIOCHEMIKA Co., Ltd.): 3.75 parts by weight

Polyvinyl alcohol (product from KURARAY Co., Ltd., PVA 105): 1.25 parts by weight

Acrylic latex (product from Hansol Chemical Co., Ltd., SAV 4720): 7.5 parts by weight

Zirconium oxy chloride (product from Junsei Co., Ltd.): 3.75 parts by weight

Sodium chloride (product from Junsei Co., Ltd.): 3.75 parts by weight

Polyethylene glycol (product from Junsei Co., Ltd.): 5 parts by weight

Water: 500 parts by weight

The composition to form a toner receptor layer and the composition to form an uppermost surface layer obtained as above were coated on a base paper with a basis weight of 110 g/m² using a bar coater, were dried at a temperature of 110° C. for 3 minutes to make a recording medium for electrophotographic applications, having approximately 10 μm of a toner receptor layer and approximately 11 μm of an uppermost surface layer.

### COMPARATIVE EXAMPLE 1

A recording medium for electrophotographic applications was prepared in the same way as in Example 1 except that a composition to form a toner receptor layer has the following composition.

Calcium carbonate (product from OMAYA Co., Ltd., Hydrocarb 60 ME): 100 parts by weight

Polyvinyl alcohol (product from KURARAY Co., Ltd., PVA 105): 1.25 parts by weight

Acrylic latex (product from Hansol Chemical Co., Ltd., SAV 4720): 7.5 parts by weight

Sodium chloride (product from Junsei Co., Ltd.): 3.75 parts by weight

Polyethylene glycol (product from Junsei Co., Ltd.): 6.25 parts by weight

Water: 500 parts by weight

### COMPARATIVE EXAMPLE 2

A recording medium for electrophotographic applications was prepared in the same way as in Example 1 except that a composition to form a toner receptor layer had the following composition.

Calcium carbonate (product from OMAYA Co., Ltd., Hydrocarb 60 ME): 100 parts by weight

Polyvinyl alcohol (product from KURARAY Co., Ltd., PVA 105): 1.25 parts by weight

Acrylic latex (product from Hansol Chemical Co., Ltd., SAV 4720): 7.5 parts by weight

Zeolite (Zeolite, BIOCHEMIKA Co., Ltd.): 18.75 parts by weight

Sodium chloride (product from Junsei Co., Ltd.): 3.75 parts by weight

Polyethylene glycol (product from Junsei Co., Ltd.): 6.25 parts by weight

Water: 500 parts by weight

### COMPARATIVE EXAMPLE 3

A recording medium for electrophotographic applications was prepared in the same way as in Example 3 except that a composition to form an uppermost surface layer has the following composition.

Calcium carbonate (product from SMI Co., Ltd., Pracarb A40): 100 parts by weight

Organic filler (product from Dow Co., Ltd., DPP 3720): 1.25 parts by weight

Polyvinyl alcohol (product from KURARAY Co., Ltd., PVA 105): 1.25 parts by weight

Acrylic latex (product from Hansol Chemical Co., Ltd., SAV 4720): 7.5 parts by weight

Zirconium oxy chloride (product from Junsei Co., Ltd.): 3.75 parts by weight

Sodium chloride (product from Junsei Co., Ltd.): 3.75 parts by weight

Polyethylene glycol (product from Junsei Co., Ltd.): 5 parts by weight

Water: 500 parts by weight

### COMPARATIVE EXAMPLE 4

A recording medium for electrophotographic applications was prepared in the same way as in Example 3 except that a composition to form a toner receptor layer had the following composition.

Calcium carbonate (product from OMAYA Co., Ltd., Hydrocarb 60 ME): 100 parts by weight

Polyvinyl alcohol (product from KURARAY Co., Ltd., PVA 105): 1.25 parts by weight

Acrylic latex (product from Hansol Chemical Co., Ltd., SAV 4720): 7.5 parts by weight

Zeolite (Zeolite, BIOCHEMIKA Co., Ltd.): 6.25 parts by weight

Sodium chloride (product from Junsei Co., Ltd.): 3.75 parts by weight

Polyethylene glycol (product from Junsei Co., Ltd.): 6.25 parts by weight

Water: 500 parts by weight

With respect to the recording media according to the Examples 1 to 4 and comparative examples 1 to 4, printing was performed using a color laser printer (product from Samsung Electronics Co., Ltd., CLP-300).

An amounts of VOC generated during printing were analyzed using a VOC measuring method performed by Blue Angel, which is a certification authority of international environment marks.

Method of Analyzing Volatile Organic Compound (VOC)

<Analysis equipment: TDS/CIS-GC/MS>

Specimens for the analysis were sampled in a TDS(Thermo Desorption System) tube (CD=6 mm, ID=4 mm, length=178 mm (7″)), and thermally annealed through the TDS to evaporate a component from the specimens. The evaporated component was introduced into a CIS (Cooling Injection System). The CIS concentrated the component and delivered the same into a GC column to analyze an occurrence amount of volatile organic compound.

<Measurement condition>

(1) Sampled amount: about 10 mg of toner

(2) GC/MS column: HP-1 ms or HP-5 ms

(3) GC oven: 40° C. (4 min)→140° C.@5° C./min
140° C. (0 min)→240° C.@10° C./min
240° C. (0 min)→290° C. (5 min)@25° C./min

(4) TDS: 25° C.→200° C. (5 min) [60° C./min] (splitless)

(5) CIS: −50° C.→320° C. (12° C./min)

<Evaluation results on the amount of VOC>

The amount of VOC was measured using a Blue Angel standard. TVOC (which is an abbreviation of total volatile compounds and is an evaluation item of VOC in the Blue Angel standard) region is defined as a region where hexane (C6) or hexadecane (C16) is detected.

TABLE 1

| | | | | Comparative | Comparative | Comparative | Comparative |
|---|---|---|---|---|---|---|---|
| | Example 1 | Example 2 | Example 3 | Ex. 1 | Ex. 2 | Ex. 3 | Ex. 4 |
| Amount of | 575847854 | 483970115 | 586490341 | 754620341 | Not evaluable | 769678965 | 749678965 |
| VOC (area) | | | | | | | |
| Relative | 0.76 | 0.64 | 0.78 | 1.00 | Not evaluable | 1.02 | 0.99 |
| Comparison | | | | | | | |
| Porous | Contained | Contained | Contained | Not | Overcontained | Not | Contained in |
| adsorptive | in toner | in toner | in | contained in | in toner | contained in | toner receptor |
| material | receptor | receptor | uppermost | toner | receptor layer | uppermost | layer but not |
| | layer | layer | surface | receptor | => Coating | surface layer | contained in |
| | | | layer | layer | error and | | uppermost |
| | | | | | paper feeding | | surface layer |
| | | | | | error | | |

As illustrated from the above table 1, the recording media prepared according to the Examples 1 to 3 illustrate a decreasing effect in the occurrence amount of VOC since the porous adsorptive material is contained in the outermost coating layers thereof. On the contrary, the recording media prepared according to the comparative examples 1 and 3 illustrate that the occurrence amount of VOC is mainly due to the nonexistence of porous adsorptive material.

In the case of the comparative example 2 which illustrates 18.75 parts by weight of porous adsorptive material, i.e., an excess amount of porous adsorptive material, a contact between the base layer and the outermost coating layer is bad and the thickness of the outermost coating layer is increased to cause a paper feeding error is observed.

In the case of the comparative example 4 in which the toner receptor layer contains porous adsorptive material and the uppermost surface layer, i.e., the outermost coating layer does not contain porous adsorptive material, the occurrence amount of VOC is not decreased is observed. This result illustrates that the adsorptive material contained in the outermost coating layer of the recording medium can effectively removed a hazardous material.

That is, it can be illustrated that only when porous adsorptive material is contained in the outermost coating layer of the recording medium, the occurrence amount of VOC is effectively decreased.

According to the present general inventive concept, since a porous adsorptive material is contained in an outermost coating layer of a recording medium for electrophotographic applications, volatile hazardous material generated from toner during a printing operation can be directly adsorbed on the recording medium to efficiently decrease or remove the occurrence of the volatile hazardous material, so that a separate filter or apparatus for removing the volatile hazardous material is not needed and thus an economical effect can be obtained.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A recording medium for electrophotographic applications, the recording medium comprising:
a base layer; and
an outermost coating layer containing a porous adsorptive material.

2. The recording medium of claim 1, wherein when the recording medium further comprises:
a toner receptor layer formed on one surface of the base layer or toner receptor layers respectively formed on both surfaces of the base layer, the outermost coating layer being the toner receptor layer.

3. The recording medium of claim 1, wherein when the recording medium comprises:
the base layer, a toner receptor layer formed on one surface of the base layer or toner receptor layers respectively formed on both surfaces of the base layer, and an uppermost surface layer formed on the toner receptor layer, the outermost coating layer being the uppermost surface layer.

4. The recording medium of claim 1, wherein the porous adsorptive material is at least one selected from the group consisting of silica, active carbon, bentonite, montmorillonite, illite and elvan.

5. The recording medium of claim 1, wherein the porous adsorptive material has an amount of 0.1 part by weight to 15 parts by weight based on 100 parts by weight of a filler.

6. The recording medium of claim 1, wherein the base layer is one selected from the group consisting of synthetic paper, wood free paper, art paper, coated paper, mixed paper, baryta paper, impregnated paper, paper board, cellulose fiber paper, transparent or semi-transparent plastic film, and a foamed sheet, and a laminated structure of two or more of the above materials.

7. The recording medium of claim 1, wherein the base layer comprises:
a thickness of 25 μm to 260 μm.

8. The recording medium of claim 1, wherein the outermost coating layer further comprises:
a filler; and
a binder.

9. The recording medium of claim 8, wherein the filler is an inorganic filler selected from the group consisting of kaolin clay, silica, calcium carbonate, talc, aluminum hydroxide, satin white, titanium dioxide, calcined clay, zinc oxide and barium sulfate, or an organic filler selected from the group consisting of styrene-based resin, acryl-based resin, polyvinyl chloride and polycarbonate.

10. The recording medium of claim 8, wherein the binder contains at least one component selected from the group consisting of polyvinyl alcohol, polyvinylpyrrolidone, methyl cellulose, hydroxypropylmethyl cellulose, gelatin, polyethyleneoxide, acryl-based polymer, polyester, polyurethane, epoxy resin, latex, and quaternary ammonium copolymer.

11. The recording medium of claim 2, wherein the toner receptor layer further comprises:
an additive.

12. The recording medium of claim 2, wherein the toner receptor layer comprises:
a thickness of 1 μm to 20 μm.

13. The recording medium of claim 3, wherein the uppermost surface layer comprises:
a thickness of 5 μm to 15 μm.
